(19) United States
(12) Patent Application Publication
(10) Pub. No.: US 2005/0063254 A1
(43) Pub. Date: Mar. 24, 2005

(54) Assembling method and device for magneto-optical head

(75) Inventors: Akihiko Yabuki, Kawasaki (JP); Mamoru Hokari, Kawasaki (JP); Shigeru Akema, Kawasaki (JP); Ayu Miyakawa, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 10/986,676

(22) Filed: Nov. 12, 2004

Related U.S. Application Data
(63) Continuation of application No. PCT/JP02/06586, filed on Jun. 28, 2002.

(51) Int. Cl. G11B 7/00

(52) U.S. Cl. 369/13.12; 369/13.32

(57) ABSTRACT

An assembling device for a magneto-optical head including a glass plate having a first surface and a second surface parallel to each other with a coil formed on the first surface, and a semispherical lens bonded to the second surface of the glass plate. The assembling device includes an XY stage movable in an X-axis direction and a Y-axis direction orthogonal to each other, a jig mounted on the XY stage, a grip mechanism for gripping the semispherical lens, and an XYZ stage for carrying the grip mechanism so that the grip mechanism is movable in the X-axis direction, the Y-axis direction, and a Z-axis direction orthogonal to each other. The assembling device further includes an interference microscope for observing the glass plate placed on the jig and the semispherical lens, a Z stage for supporting the interference microscope so that the interference microscope is movable in the Z-axis direction, an image pickup unit for picking up an observed image from the interference microscope, an image processing unit connected to the image pickup unit, and a control unit connected to the XY stage, the XYZ stage, the Z stage, and the image processing unit.

This is a continuation of International PCT Application NO. PCT/JP02/06586, filed Jun. 28, 2002, which was not published in English.

### FIELD OF THE INVENTION

The present invention relates to an assembling method and device for a magneto-optical head.

### DESCRIPTION OF THE RELATED ART

With an increase in quantity of information such as image information including moving images in recent years, it is desirable to more reduce the size of a beam spot to be focused on an optical recording medium, so as to realize higher-density recording to the optical recording medium. Further, the numerical aperture of an objective lens becomes larger, and the operating distance between the optical recording medium and the objective lens becomes shorter. There is a limit to the manufacture of an aspherical single lens for the objective lens, so that increasing the numerical aperture of a single objective lens is limited. To achieve a larger numerical aperture, there has been proposed an optical pickup using two combined lenses including a semispherical lens located on the laser focusing side.

As a configuration such that the combined lenses are used in a magnetic modulation recording type magneto-optical disk drive, there has been proposed a magneto-optical head including a glass plate having a coil, with the semispherical lens mounted on the glass plate. In this magneto-optical head, the inner circumference of the coil is minimized close to a beam path so that the coil may generate a magnetic field efficiently at a beam focusing position. Accordingly, in joining the glass plate with the coil and the semispherical lens, it is necessary to accurately align the optical axis of the semispherical lens and the center of the coil, so as to avoid the interference between the laser beam and the inner circumference of the coil.

If the inner diameter of the coil is increased to prevent the interference between the laser beam and the inner circumference of the coil, the magnetic field to be generated by the coil must be increased to ensure a sufficient magnetic field required for recording/reproduction of information to/from the medium. Therefore, it is desirable to minimize the inner diameter of the coil. Accordingly, by accurately aligning the optical axis of the semispherical lens and the center of the coil, the coil can be reduced in size and a compact optical head can be provided. Consequently, the coil can be driven by a small current for generating a magnetic field without any influence on the light quantity and the beam shape, thereby efficiently applying a necessary magnetic field to the medium.

### SUMMARY OF THE INVENTION

It is therefore an object of the present invention to provide an assembling method and device for a magneto-optical head which can accurately align the optical axis of the semispherical lens and the center of the coil.

In accordance with an aspect of the present invention, there is provided an assembling device for a magneto-optical head including a glass plate having a first surface and a second surface parallel to each other with a coil formed on the first surface, and a semispherical lens bonded to the second surface of the glass plate. The assembling device includes an XY stage movable in an X-axis direction and a Y-axis direction orthogonal to each other; a jig mounted on the XY stage; a grip mechanism for gripping the semispherical lens; an XYZ stage for carrying the grip mechanism so that the grip mechanism is movable in the X-axis direction, the Y-axis direction, and a Z-axis direction orthogonal to each other; a microscope for observing the glass plate placed on the jig and the semispherical lens; a Z stage for supporting the microscope so that the microscope is movable in the Z-axis direction; an image pickup unit for picking up an observed image from the microscope; an image processing unit connected to the image pickup unit; and a control unit connected to the XY stage, the XYZ stage, the Z stage, and the image processing unit for controlling the XY stage, the XYZ stage, the Z stage, and the image processing unit.

Preferably, the assembling device for the magneto-optical head further includes an adhesive supplying unit for supplying an adhesive to the second surface of the glass plate, and a UV light source for directing UV light to the supplied adhesive. Preferably, the microscope includes an interference microscope. More preferably, the assembling device for the magneto-optical head further includes a display unit connected to the image processing unit, and an XY rotating stage for correcting the inclination of the glass plate placed on the jig, the XY rotating stage being connected to the control unit.

In accordance with another aspect of the present invention, there is provided an assembling method for a magneto-optical head including a glass plate having a first surface and a second surface parallel to each other with a coil formed on the first surface, and a semispherical lens bonded to the second surface of the glass plate. The assembling method includes the steps of placing the glass plate on a jig; bringing the focus of an interference microscope to the coil formed on the glass plate; picking up a first observed image from the interference microscope by using an image pickup unit; calculating the coordinates of a central position of the coil from a first picked-up image corresponding to the first observed image by using an image processing unit; moving the jig so that the central position of the coil coincides with a central position of a visual field of the image pickup unit; supplying an adhesive to the second surface of the glass plate; placing the semispherical lens on the second surface of the glass plate; bringing the focus of the interference microscope to a position slightly lower than the vertex of the semispherical lens; observing moire fringes appearing on the surface of the semispherical lens by using the interference microscope; picking up a second observed image from the interference microscope by using the image pickup unit; calculating the coordinates of a central position of the semispherical lens from a second picked-up image corresponding to the second observed image by using the image processing unit; moving the jig so that the central position of the semispherical lens coincides with the central position of the visual field of the image pickup unit; and curing the adhesive to bond the semispherical lens to the glass plate.

Preferably, the assembling method for the magneto-optical head further includes the steps of bringing the focus of the interference microscope to the second surface of the glass plate before the step of bringing the focus of the interference microscope to the coil; observing interference fringes on the glass plate; slightly raising the focus of the interference microscope; measuring the inclination of the glass plate from a direction of movement of the interference fringes; and adjusting the glass plate to a horizontal position.

For example, the step of calculating the coordinates of the central position of the coil includes the steps of preliminarily recording the pattern image of the shape of the inner circumference of the coil and the central position of the coil as a master pattern, and making the first picked-up image coincide with the master pattern. Alternatively, the coil may have a circular dielectric protective layer having a radius equal to a minimum distance from the center of the coil to the inner circumferential circle of the coil. In this case, the step of calculating the coordinates of the central position of the coil includes the step of obtaining the center of the circular dielectric protective layer. As a modification of this configuration, the coil may have a dielectric protective layer formed outside a circular pattern having a radius equal to a minimum distance from the center of the coil to the inner circumferential circle of the coil. In this case, the step of calculating the coordinates of the central position of the coil includes the step of obtaining the center of the circular pattern.

In accordance with a further aspect of the present invention, there is provided a magneto-optical head including a glass plate having a first surface and a second surface parallel to each other with a coil formed on the first surface; a first lens bonded to the second surface of the glass plate; a second lens spaced a predetermined distance from the first lens; and a lens holder having one end bonded to the glass plate and the other end for holding the second lens; the coil having a circular dielectric protective layer having a radius equal to a minimum distance from the center of the coil to the inner circumferential circle of the coil.

In accordance with a still further aspect of the present invention, there is provided a magneto-optical head including a glass plate having a first surface and a second surface parallel to each other with a coil formed on the first surface; a first lens bonded to the second surface of the glass plate; a second lens spaced a predetermined distance from the first lens; and a lens holder having one end bonded to the glass plate and the other end for holding the second lens; the coil having a dielectric protective layer formed outside a circular pattern having a radius equal to a minimum distance from the center of the coil to the inner circumferential circle of the coil.

The above and other objects, features and advantages of the present invention and the manner of realizing them will become more apparent, and the invention itself will best be understood from a study of the following description and appended claims with reference to the attached drawings showing some preferred embodiments of the invention.

### BRIEF DESCRIPTION OF THE DRAWINGS

FIG. 1 is a sectional view of a magneto-optical head according to a preferred embodiment of the present invention;

FIG. 2 is a schematic view showing the configuration of an assembling device for a magneto-optical head according to a preferred embodiment of the present invention;

FIG. 3 is a flowchart showing an assembling method for a magneto-optical head according to a preferred embodiment of the present invention;

FIGS. 4A to 4D are illustrations of interference fringes generated on the surface of a glass plate in the case that the glass plate is inclined with respect to a horizontal plane;

FIG. 5 is a plan view of a coil according to a preferred embodiment of the present invention;

FIG. 6 is a plan view of a coil according to another preferred embodiment of the present invention; and

FIG. 7 is an observed image by an interference microscope, showing moire fringes generated on a semispherical lens.

### DETAILED DESCRIPTION OF THE PREFERRED EMBODIMENTS

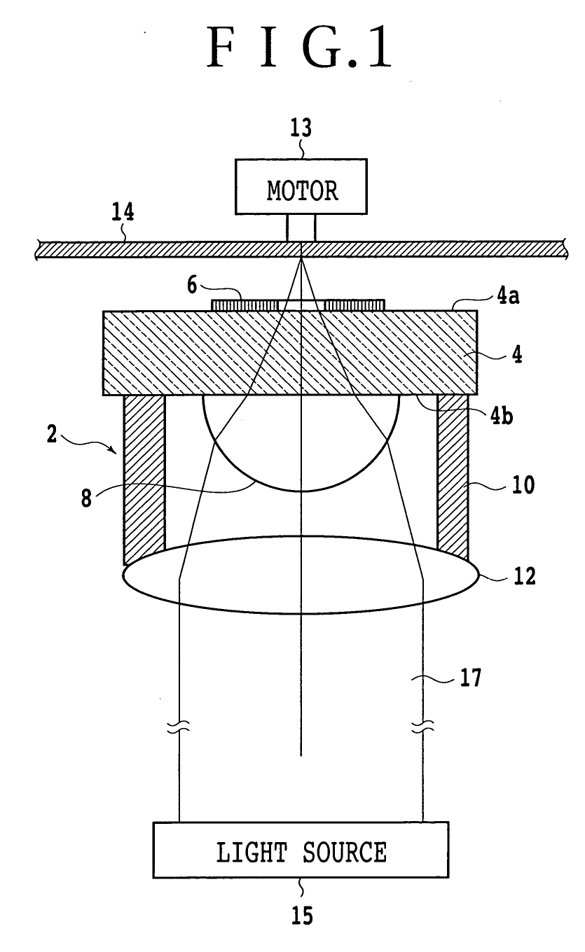

FIG. 1 shows a sectional view of a magneto-optical head 2 according to a preferred embodiment of the present invention. The magneto-optical head 2 includes a glass plate 4 having a first surface 4a and a second surface 4b parallel to each other. A coil 6 for generating a magnetic field is formed on the first surface 4a of the glass plate 4 by sputtering or vacuum evaporation, for example. A semispherical lens 8 is bonded to the second surface 4b of the glass plate 4 by an optical adhesive. Reference numeral 10 denotes a lens holder having one end bonded to the glass plate 4 and the other end for holding a lens 12. The optical axis of the semispherical lens 8 and the optical axis of the lens 12 are aligned to each other. Further, the optical axis of the semispherical lens 8 is substantially aligned to the center of the coil 6.

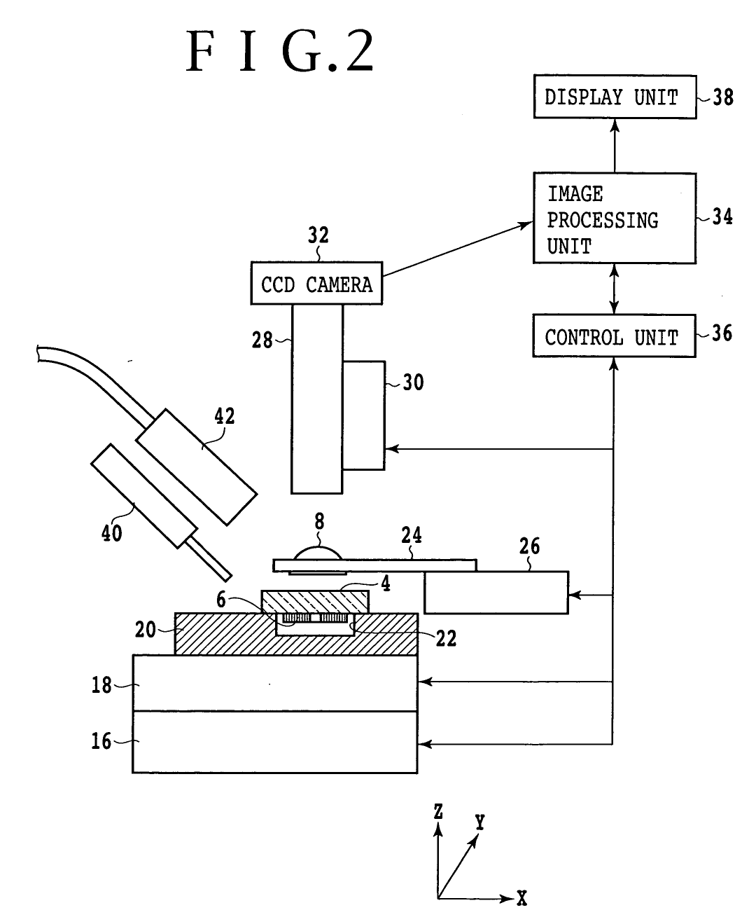

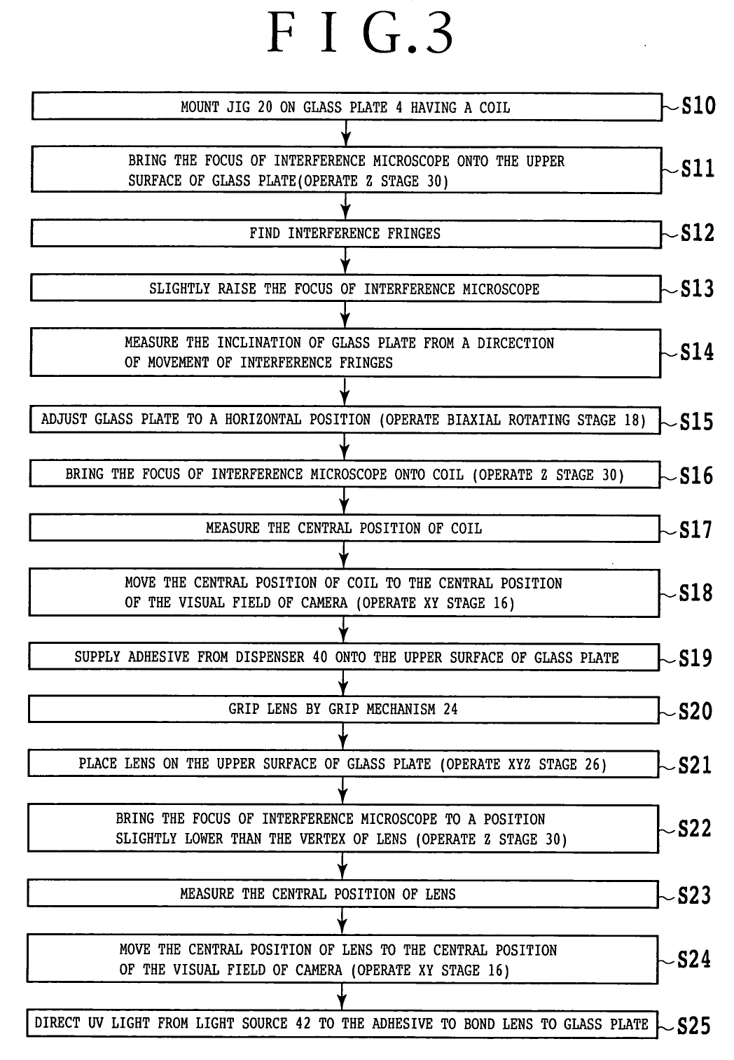

The magneto-optical head 2 is a magneto-optical head for use in a magnetic modulation recording type magneto-optical disk drive. This magneto-optical head is of a front illumination type such that the coil 6 is located on the laser beam irradiation side where a laser beam 17 is directed onto a magneto-optical recording medium (magneto-optical disk) 14 to be rotated by a motor 13. That is, the laser beam 17 is emitted from a light source 15 such as a laser diode, and is directed onto the magneto-optical recording medium 14. The coil 6 is located on the side of the magneto-optical recording medium 14 where the laser beam 17 enters. However, the magneto-optical head 2 shown in FIG. 1 is a typical magneto-optical head to which the present invention is applicable, and the application of the present invention is not limited to the magnetic modulation recording type or the front illumination type as mentioned above. Further, the magneto-optical recording medium according to the present invention is not limited to a disk-shaped recording medium, but may include a card-shaped recording medium. An assembling device and method for assembling the magneto-optical head 2 will now be described with reference to FIGS. 2 and 3.

FIG. 2 is a schematic view showing the configuration of an assembling device for a magneto-optical head according to a preferred embodiment of the present invention. Reference numeral 16 denotes an XY stage movable in an X-axis direction and a Y-axis direction orthogonal to each other. An XY rotating stage (biaxial rotating stage) 18 rotatable about the X axis and the Y axis is mounted on the XY stage 16. A jig 20 having a recess 22 is mounted on the XY rotating stage 18.

Reference numeral 24 denotes a grip mechanism for gripping the semispherical lens 8. The grip mechanism 24 is mounted on an XYZ stage 26 movable in the X-axis direction, the Y-axis direction, and a Z-axis direction orthogonal to each other. Reference numeral 28 denotes an interference microscope, which is supported to a Z stage 30 movable in the Z-axis direction. A CCD camera 32 is mounted on the interference microscope 28. The CCD camera 32 is connected to an image processing unit 34. An output from the image processing unit 34 is displayed by a display unit 38. The XY stage 16, the XY rotating stage 18, the XYZ stage 26, the Z stage 30, and the image processing unit 34 are connected to a control unit 36 such as a personal computer, and they are controlled by the control unit 36. Reference numeral 40 denotes an adhesive dispenser for supplying an optical adhesive. This optical adhesive is a UV curing type adhesive. Reference numeral 42 denotes a UV light source for directing UV light to this optical adhesive.

An assembling method for a magneto-optical head according to a preferred embodiment of the present invention will now be described with reference to the flowchart shown in FIG. 3 in conjunction with FIG. 2. In step S10, the glass plate 4 is mounted on the jig 20 in the condition that the first surface (coil formed surface) of the glass plate 4 is oriented downward. In step S11, the Z stage 30 is operated to bring the focus of the interference microscope 28 onto the upper surface (second surface) of the glass plate 4 and to find interference fringes in an observed image obtained by the interference microscope 28 (step S12). Thereafter, the focus of the interference microscope 28 is slightly raised (step S13), and the inclination of the glass plate 4 is measured from the direction of movement of the interference fringes (step S14).

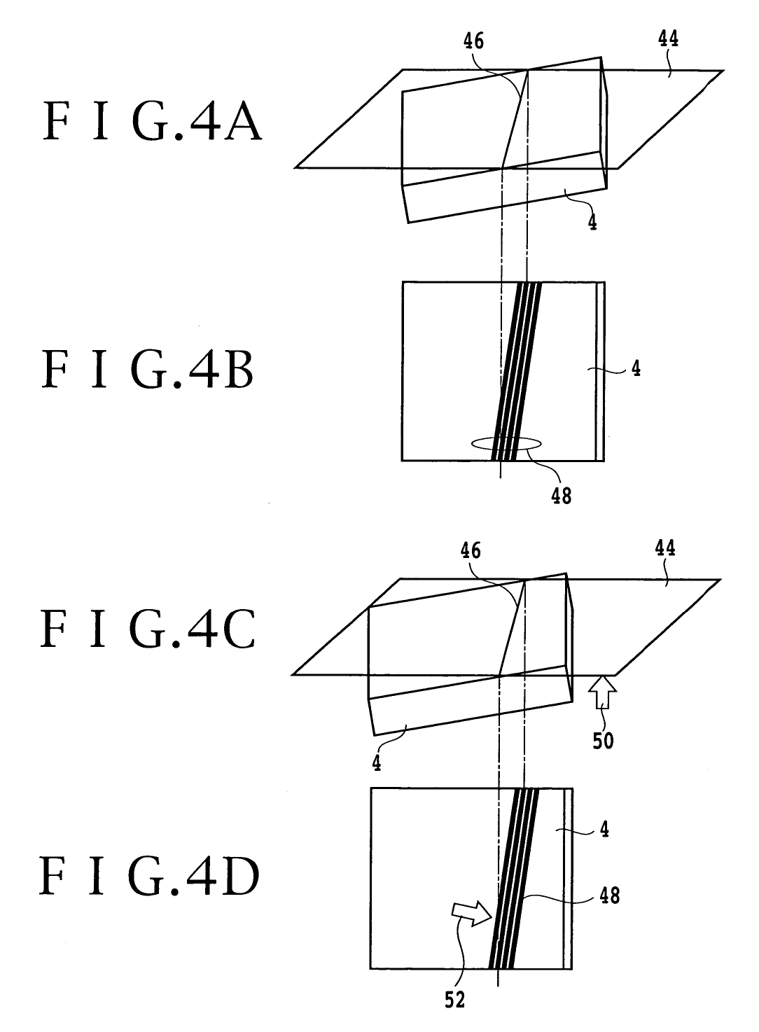

The measurement of the inclination of the glass plate 4 will now be described in detail with reference to FIGS. 4A to 4D. In FIG. 4A, reference numeral 44 denotes a reference horizontal plane perpendicular to the optical axis of the interference microscope 28. Reference numeral 46 denotes a line formed by the intersection of the reference horizontal plane 44 and the upper surface (second surface) of the glass plate 4. This line 46 is referred to as an edge line. FIG. 4B shows an observed image (field image) of the glass plate 4 in the condition shown in FIG. 4A as obtained by the interference microscope 28. In the case that the glass plate 4 is inclined with respect to the reference horizontal plane 44, interference fringes 48 parallel to the edge line 46 are generated on the upper surface of the glass plate 4. The larger the inclination of the glass plate 4, the smaller the spacing of the interference fringes 48.

FIG. 4C schematically shows the case where the focus of the interference microscope 28 is slightly raised as shown by an arrow 50. In this case, an observed image obtained by the interference microscope 28 is shown in FIG. 4D. As shown by an arrow 52 in FIG. 4D, the interference fringes 48 are moved in the direction of inclination (higher side) of the glass plate 4. Accordingly, the inclination of the glass plate 4 can be measured from the direction of movement of the interference fringes 48.

After determining the direction of inclination of the glass plate 4 in step S14, the program proceeds to step S15. In step S15, the XY rotating stage 18 is operated to adjust the inclination of the glass plate 4 so that the glass plate 4 becomes parallel to the reference horizontal plane 44. In other words, the inclination of the glass plate 4 is adjusted so that the interference fringes 48 disappear, because the interference fringes 48 are generated when the glass plate 4 is inclined. After thus making the glass plate 4 horizontal, the program proceeds to step S16. In step S16, the Z stage 30 is operated to bring the focus of the interference microscope 28 onto the coil 6, and the central position of the coil 6 is measured by the image processing unit 34 (step S17). In other words, the coordinates of the central position of the coil 6 are calculated by the image processing unit 34.

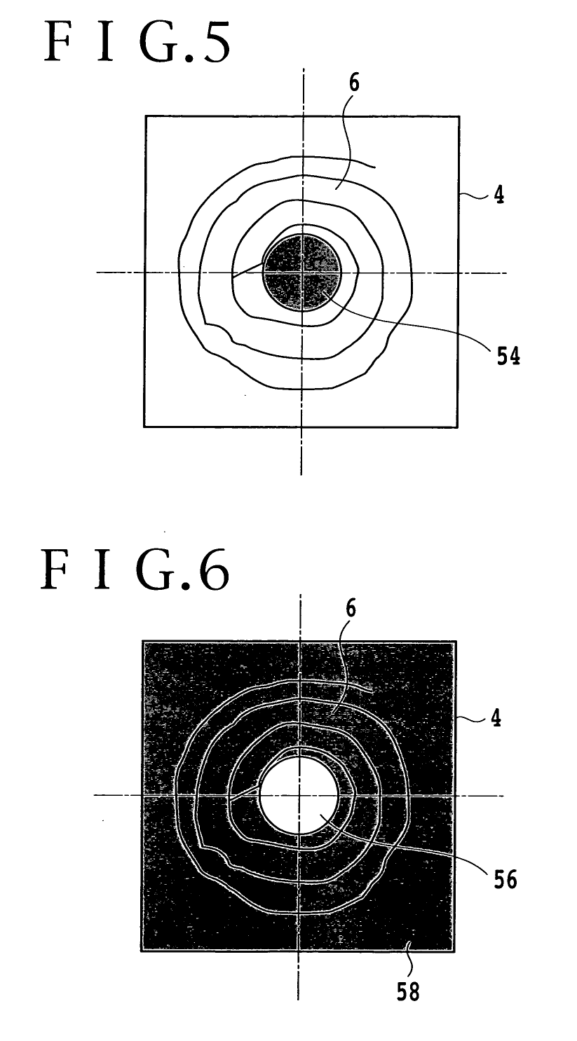

The step of calculating the coordinates of the central position of the coil 6 in step S17 may include the steps of preliminarily recording the pattern image of the shape of the inner circumference of the coil 6 and the central position of the coil 6 as a master pattern in the image processing unit 34 and making the picked-up screen by the CCD camera 32 coincide with the master pattern. That is, this step is performed by so-called pattern matching. Alternatively, a coil 6 having a circular dielectric protective layer 54 as shown in FIG. 5 may be used. The circular dielectric protective layer 54 has a radius equal to a minimum distance from the center of the coil 6 to the inner circumferential circle of the coil 6. The circular dielectric protective layer 54 is formed from an alumina film having a thickness of about lam, for example. In this case, the step of calculating the coordinates of the central position of the coil 6 includes the step of obtaining the center of the circular dielectric protective layer 54.

FIG. 6 shows a modification of the configuration shown in FIG. 5. In this modification, the coil 6 has a dielectric protective layer 58 formed outside a circular pattern 56 having a radius equal to the minimum distance from the center of the coil 6 to the inner circumferential circle of the coil 6. The dielectric protective layer 58 is formed from an alumina film, for example. In this case, the step of calculating the coordinates of the central position of the coil 6 includes the step of obtaining the center of the circular pattern 56.

The program next proceeds to step S18. In step S18, the XY stage 16 is operated to move the jig 20 so that the central position of the coil 6 coincides with an assembly reference position, i.e., the central position of the visual field of the CCD camera 32. In the next step, a UV curing type optical adhesive is supplied to the upper surface of the glass plate 4 by the adhesive dispenser 40 (step S19). In the next step, the semispherical lens 8 is gripped by the grip mechanism 24 (step S20), and the XYZ stage 26 is next operated to place the semispherical lens 8 on the upper surface of the glass plate 4 (step S21).

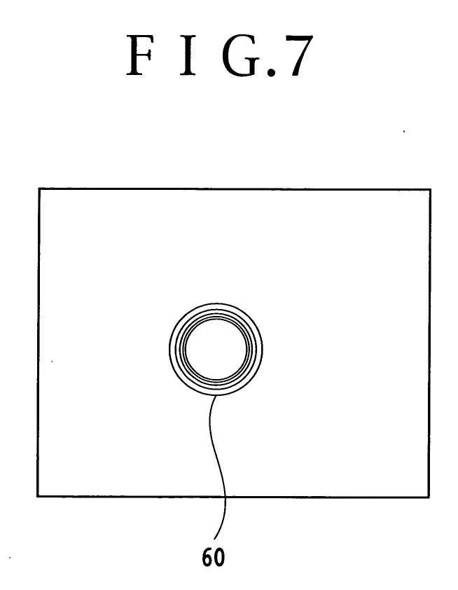

The program next proceeds to step S22. In step S22, the Z stage 30 is operated to bring the focus of the interference microscope 28 to a position slightly lower than the vertex of the semispherical lens 8. The program next proceeds to step S23, in which the central position of the lens 8 is measured. The measurement of the central position of the lens 8 is performed by observing concentric moire fringes 60 appearing on the surface of the lens 8 as shown in FIG. 7, picking up an image of this moire fringes 60 by means of the CCD camera 32, and calculating the coordinates of the central position of the lens 8 from the picked-up image by means of the image processing unit 34. The coordinates thus calculated are set as the position of the vertex of the lens 8.

In the next step, the XY stage 16 is operated to move the jig 20 so that the optical axis of the lens 8 obtained above coincides with the central position of the visual field of the CCD camera 32 (step S24). In other words, the XY stage 16 is driven so that the optical axis of the lens 8 coincides with the assembly reference position mentioned above. After aligning the lens 8 in this manner, the program proceeds to step S25, in which UV light is directed from the UV light source 42 to the adhesive supplied to the glass plate 4, thereby curing the adhesive to bond the lens 8 to the glass plate 4.

According to the present invention as described above in detail, a magneto-optical head having a coil and a lens can be assembled automatically and efficiently. That is, it is possible to realize the assembly such that the optical axis of the semispherical lens is accurately aligned with the central position of the coil. Since the optical axis of the semispherical lens and the center of the coil can be accurately aligned as mentioned above, it is possible to provide a compact magneto-optical head having a small coil, so that the coil can be driven by a small current for generating a magnetic field without any influence on the light quantity and the beam shape, thereby efficiently applying a necessary magnetic field to the medium.

1. An assembling device for a magneto-optical head including a glass plate having a first surface and a second surface parallel to each other with a coil formed on said first surface, and a semispherical lens bonded to said second surface of said glass plate, said assembling device comprising:
an XY stage movable in an X-axis direction and a Y-axis direction orthogonal to each other;
a jig mounted on said XY stage;
a grip mechanism for gripping said semispherical lens;
an XYZ stage for carrying said grip mechanism so that said grip mechanism is movable in said X-axis direction, said Y-axis direction, and a Z-axis direction orthogonal to each other;
a microscope for observing said glass plate placed on said jig and said semispherical lens;
a Z stage for supporting said microscope so that said microscope is movable in said Z-axis direction;
an image pickup unit for picking up an observed image from said microscope;
an image processing unit connected to said image pickup unit; and
a control unit connected to said XY stage, said XYZ stage, said Z stage, and said image processing unit for controlling said XY stage, said XYZ stage, said Z stage, and said image processing unit.

2. The assembling device for a magneto-optical head according to claim 1, further comprising an adhesive supplying unit for supplying an adhesive to said second surface of said glass plate.

3. The assembling device for a magneto-optical head according to claim 2, further comprising a UV light source for directing UV light to said adhesive supplied to said second surface of said glass plate.

4. The assembling device for a magneto-optical head according to claim 1, further comprising a display unit connected to said image processing unit.

5. The assembling device for a magneto-optical head according to claim 1, further comprising an XY rotating stage for correcting the inclination of said glass plate placed on said jig, said XY rotating stage being connected to said control unit.

6. The assembling device for a magneto-optical head according to claim 1, wherein said microscope comprises an interference microscope.

7. An assembling method for a magneto-optical head including a glass plate having a first surface and a second surface parallel to each other with a coil formed on said first surface, and a semispherical lens bonded to said second surface of said glass plate, said assembling method comprising the steps of:
placing said glass plate on a jig;
bringing the focus of an interference microscope to said coil formed on said glass plate;
picking up a first observed image from said interference microscope by using an image pickup unit;
calculating the coordinates of a central position of said coil from a first picked-up image corresponding to said first observed image by using an image processing unit;
moving said jig so that the central position of said coil coincides with a central position of a visual field of said image pickup unit;
supplying an adhesive to said second surface of said glass plate;
placing said semispherical lens on said second surface of said glass plate;
bringing the focus of said interference microscope to a position slightly lower than the vertex of said semispherical lens;
observing moire fringes appearing on the surface of said semispherical lens by using said interference microscope;
picking up a second observed image from said interference microscope by using said image pickup unit;
calculating the coordinates of a central position of said semispherical lens from a second picked-up image corresponding to said second observed image by using said image processing unit;
moving said jig so that the central position of said semispherical lens coincides with the central position of the visual field of said image pickup unit; and
curing said adhesive to bond said semispherical lens to said glass plate.

8. The assembling method for a magneto-optical head according to claim 7, further comprising the steps of:
bringing the focus of said interference microscope to said second surface of said glass plate before the step of bringing the focus of said interference microscope to said coil;
observing interference fringes on said glass plate;
slightly raising the focus of said interference microscope;
measuring the inclination of said glass plate from a direction of movement of said interference fringes; and
adjusting said glass plate to a horizontal position.

9. The assembling method for a magneto-optical head according to claim 7, wherein the step of curing said adhesive is attained by directing UV light to said adhesive.

10. The assembling method for a magneto-optical head according to claim 7, wherein the step of calculating the coordinates of the central position of said coil comprises the steps of preliminarily recording the pattern image of the shape of the inner circumference of said coil and the central position of said coil as a master pattern, and making said first picked-up image coincide with said master pattern.

11. The assembling method for a magneto-optical head according to claim 7, wherein said coil has a circular dielectric protective layer having a radius equal to a minimum distance from the center of said coil to the inner circumferential circle of said coil;
the step of calculating the coordinates of the central position of said coil comprising the step of obtaining the center of said circular dielectric protective layer.

12. The assembling method for a magneto-optical head according to claim 7, wherein said coil has a dielectric protective layer formed outside a circular pattern having a radius equal to a minimum distance from the center of said coil to the inner circumferential circle of said coil;
the step of calculating the coordinates of the central position of said'coil comprising the step of obtaining the center of said circular pattern.

13. A magneto-optical head comprising:
a glass plate having a first surface and a second surface parallel to each other with a coil formed on said first surface;
a first lens bonded to said second surface of said glass plate;
a second lens spaced a predetermined distance from said first lens; and
a lens holder having one end bonded to said glass plate and the other end for holding said second lens;
said coil having a circular dielectric protective layer having a radius equal to a minimum distance from the center of said coil to the inner circumferential circle of said coil.

14. A magneto-optical head comprising:
a glass plate having a first surface and a second surface parallel to each other with a coil formed on said first surface;
a first lens bonded to said second surface of said glass plate;
a second lens spaced a predetermined distance from said first lens; and
a lens holder having one end bonded to said glass plate and the other end for holding said second lens;
said coil having a dielectric protective layer formed outside a circular pattern having a radius equal to a minimum distance from the center of said coil to the inner circumferential circle of said coil.

15. A magneto-optical disk drive for recording/reproducing information to/from a magneto-optical recording medium, comprising:
a motor for rotating said magneto-optical recording medium;
a light source for generating a light beam; and
a magneto-optical head for focusing said light beam onto said magneto-optical recording medium;
said magneto-optical head comprising:
a glass plate having a first surface and a second surface parallel to each other with a coil formed on said first surface;
a first lens bonded to said second surface of said glass plate;
a second lens spaced a predetermined distance from said first lens; and
a lens holder having one end bonded to said glass plate and the other end for holding said second lens;
said coil having a circular dielectric protective layer having a radius equal to a minimum distance from the center of said coil to the inner circumferential circle of said coil.

16. A magneto-optical disk drive for recording/reproducing information to/from a magneto-optical recording medium, comprising:
a motor for rotating said magneto-optical recording medium;
a light source for generating a light beam; and
a magneto-optical head for focusing said light beam onto said magneto-optical recording medium;
said magneto-optical head comprising:
a glass plate having a first surface and a second surface parallel to each other with a coil formed on said first surface;
a first lens bonded to said second surface of said glass plate;
a second lens spaced a predetermined distance from said first lens; and
a lens holder having one end bonded to said glass plate and the other end for holding said second lens;
said coil having a dielectric protective layer formed outside a circular pattern having a radius equal to a minimum distance from the center of said coil to the inner circumferential circle of said coil.
